(19) United States
(12) Patent Application Publication
(10) Pub. No.: US 2024/0361804 A1
(43) Pub. Date: Oct. 31, 2024

(54) COMPUTER DOCKING STATION

(71) Applicant: Humanscale Corporation, New York, NY (US)

(72) Inventors: Kingyu Li, Milburn, NJ (US); G. Justin Meeks, Willow Spring, NC (US); David Wong, New York, NY (US)

(21) Appl. No.: 18/644,596

(22) Filed: Apr. 24, 2024

Related U.S. Application Data
(60) Provisional application No. 63/461,677, filed on Apr. 25, 2023.

(51) Int. Cl. G06F 1/16

(52) U.S. Cl. CPC G06F 1/1632

(57) ABSTRACT

A computer docking station devised to operate in different manufacturer-configured modes is disclosed. In Split Dock Mode, the computer docking station utilizes a lower dock subassembly (LDS) positioned beneath the work surface for connection to cables infrequently disconnected during normal operation and an upper dock subassembly (UDS) comprising one or more data ports positioned on top of the work surface. In Hub Mode, the UDS functions alone to provide a data hub. In Charging Mode, the UDS functions alone to provide charging ports only, with no data-transfer capability. In Dock Mode, the LDS functions alone to provide a docking station. This design allows manufacturers to sell different configurations without having to keep a stock of multiple different pieces of hardware-only a small change to a single resistor in the UDS's PCBA is necessary to change the UDS from Hub/Split Dock Mode to Charging Mode.

### RELATED APPLICATION

This application claims the priority benefit under USC § 119 to U.S. Provisional Application No. 63/461,677, filed Apr. 25, 2023, which is incorporated by reference herein in its entirety.

### BACKGROUND OF THE INVENTION

Advances in processors, battery life, and visual displays have vastly improved the performance possibilities of laptop computers. With wireless mobility and connectivity becoming a necessity in today's business environment, many businesses and entrepreneurs have chosen to use laptop computers in lieu of desktops in the workplace. However, laptops typically have smaller keyboards than the standard keyboards utilized with desktops, and a standard mouse is generally preferred by users in the office environment over the built-in touchpad or trackpad of laptop computers. In addition, prolonged use of a laptop alone can be an uncomfortable experience for the user.

A docking station allows laptop computers to become a substitute for a desktop computer without sacrificing the mobile computer functionality of the machine. For example, port replicator-type docking stations allow multiple peripherals—such as a keyboard, a printer, a mouse, and/or one or more monitors—to be connected to the laptop simultaneously by simply connecting the laptop to the docking station. Thus, the user can get access to an external full-sized keyboard, standard mouse, full-size monitor(s), a printer/scanner, and a wired network connection when working in the office environment. Ergonomic positioning of the external keyboard and monitor allow the user to assume a more comfortable, neutral posture at the workstation, thus reducing the musculoskeletal stress typically associated with the prolonged use of laptop computers.

In a typical office configuration, the docking station will be located on the work surface to allow the user to easily connect the laptop to the dock, with several cables connected to it to provide power, connect to the laptop, and connect to other peripherals. These current generation docking stations leave permanent cables that are infrequently disconnected during normal operation, such as cables for Ethernet or monitor connections, exposed on the work surface, creating a cluttered work environment.

### SUMMARY

One embodiment of the invention disclosed herein is directed to a computer docking station devised to save desktop space while also eliminating the presence of permanent cables that can clutter the work surface. The computer docking station includes an upper dock subassembly capable of transmitting power, data, video, and/or audio signals through a single adaptor port hidden beneath a removable cover, which not only improves aesthetics, but also eliminates the safety hazard of having exposed cables on the work surface and prevents users from intentionally or unintentionally tempering with the adaptor cable. The single, hidden adaptor port of the upper dock subassembly allows the computer docking station to operate in several different modes, depending on manufacturer configuration.

In Split Dock Mode, the computer docking station utilizes a split design, with a lower dock subassembly positioned beneath the work surface for connection to cables infrequently disconnected during normal operation and the upper dock subassembly comprising one or more data ports positioned on top of the work surface. In Hub Mode, the upper dock subassembly functions without the lower dock subassembly to provide a data hub. In Charging Mode, the upper dock subassembly functions without the lower dock subassembly to provide charging ports only, with a data-enabling resistor turned off in the upper dock subassembly's PCBA. In Dock Mode, the lower dock subassembly functions without the upper dock subassembly to provide a docking station. These different modes allow manufacturers to sell different configurations to different users without having to keep a stock of multiple different pieces of hardware-only a small change to a single resistor in the upper dock subassembly PCBA is necessary to change the upper dock subassembly from Hub/Split Dock Mode to Charging Mode.

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a front perspective view of one embodiment of the computer docking station according to the present disclosure.

FIG. 2 is a partially exploded view of the upper dock subassembly of the computer docking station shown in FIG. 1.

FIG. 3 is a more fully exploded view of the upper dock subassembly of the computer docking station shown in FIG. 1.

FIG. 4 is a bottom perspective view of the lower dock subassembly of the computer docking station shown in FIG. 1.

FIG. 5 is a perspective view of an embodiment of the upper dock subassembly and base subassembly of the computer docking station shown in FIG. 1.

FIG. 6 is a right-side view of an embodiment of the upper dock subassembly and base subassembly of the computer docking station shown in FIG. 1.

FIG. 7 is a front view of an embodiment of the upper dock subassembly and base subassembly of the computer docking station shown in FIG. 1.

FIG. 8 is a high-level system block diagram of the upper port housing of the upper dock subassembly of the computer docking station shown in FIG. 1.

FIG. 9 is a right side view of an embodiment of the lower dock subassembly of the computer docking station shown in FIG. 1.

FIG. 10 is a left side view of an embodiment of the lower dock subassembly of the computer docking station shown in FIG. 1.

FIG. 11 is a front side view of an embodiment of the lower dock subassembly of the computer docking station shown in FIG. 1.

FIG. 12 is a top view of an embodiment of the lower dock subassembly of the computer docking station shown in FIG. 1.

FIG. 13 is a high-level system block diagram of the lower port housing of the lower dock subassembly of the computer docking station shown in FIG. 1.

FIG. 14 is an adaptor cable that may be used in one embodiment of the computer docking station shown in FIG. 1 to connect the adaptor port of the upper dock subassembly to a power source in a configuration such as that shown in FIG. 19.

FIG. 15 is an adaptor cable that may be used in one embodiment of the computer docking station shown in FIG. 1 to connect the adaptor port of the upper dock subassembly to the lower dock subassembly in a configuration such as that shown in FIG. 17.

FIG. 16 is an adaptor cable that may be used in one embodiment of the computer docking station shown in FIG. 1 to connect the adaptor port of the upper dock subassembly to both a power source and a computer monitor in a configuration such as that shown in FIG. 18.

FIG. 17 is a graphical representation of the computer docking station shown in FIG. 1 in Split Dock Mode, wherein the upper dock subassembly connects to the lower dock subassembly to form one complete system.

FIG. 18 is a graphical representation of the computer docking station shown in FIG. 1 in USB Hub Mode, wherein the upper dock subassembly connects to a power source and all peripherals without use of the lower dock subassembly.

FIG. 19 is a graphical representation of the computer docking station shown in FIG. 1 in Charging Mode, wherein the upper dock subassembly connects to a power source only and functions without data transfer capability.

FIG. 20 is a graphical representation of the computer docking station shown in FIG. 1 in Dock Mode, wherein the lower dock subassembly connects to a power source and all peripherals without use of the upper dock subassembly.

### DETAILED DESCRIPTION OF THE PREFERRED EMBODIMENTS

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

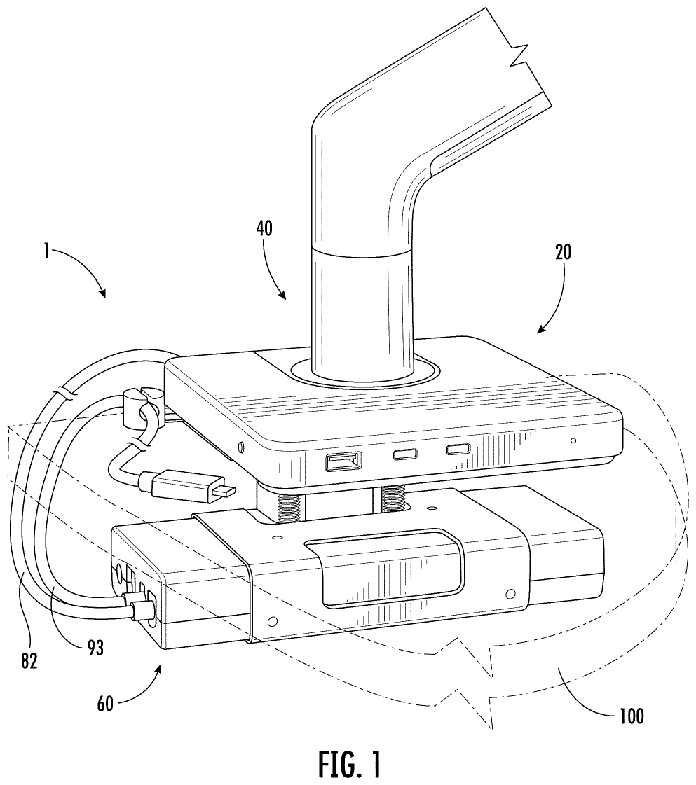

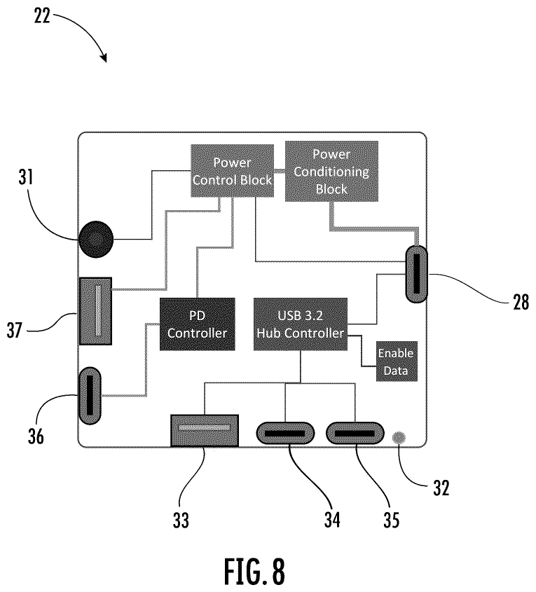

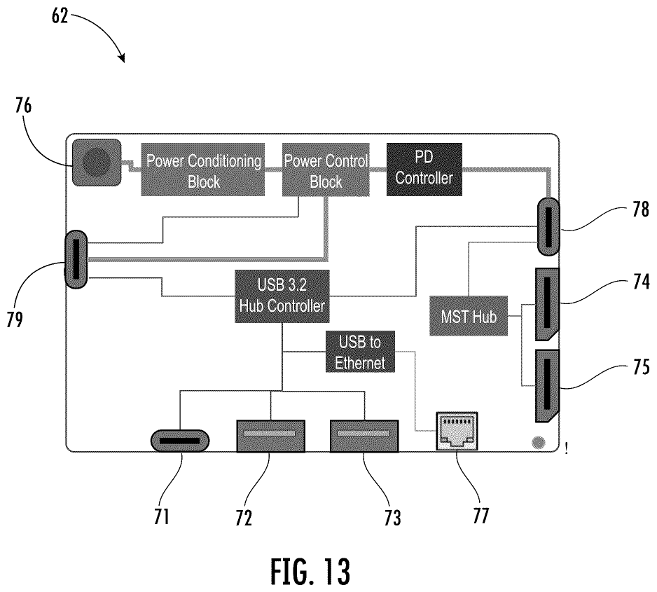

FIGS. 1-19 depict exemplary embodiments of the computer docking station. Referring now to FIG. 1, the computer docking station 1 can comprise an upper dock subassembly 20 and a lower dock subassembly 60, both releasably connected to a base subassembly 40 that secures the entire docking station 1 to a work surface or desk 100. The upper dock subassembly 20 may house active data ports (i.e., frequently connected/disconnected) and an adaptor port that is capable of transmitting power, data, video, and audio signals, while the lower doc subassembly 60 may house passive data ports (i.e., infrequently connected/disconnected). Computer docking station 1 can operate with only the upper dock subassembly 20, connecting with newer monitors and a power source through a single adaptor port on the upper dock subassembly 20. Alternatively, the user can choose to add the lower dock subassembly 60. In one embodiment, computer docking station 1 is configured such that only power for charging is provided through upper dock subassembly 20. In another embodiment, the computer docking station 1 is configured to provide compatibility with “All-in-One” monitors through the upper dock subassembly 20. In another embodiment, with the addition of lower dock subassembly 60, the computer docking station is configured to provide additional connectivity to traditional monitors through DisplayPort, USBA, USBC, and Ethernet connections. Alternative connections may include, without limitation, USB-B, DVI, HDMI connections. When the computer docking station 1 includes the lower dock subassembly 60, an adaptor cable 82 can be used to operatively connect the lower dock subassembly 60 and the upper dock subassembly 20. A monitor, mouse, keyboard, laptop, and other computer peripherals may be connected to the active data ports of the upper dock subassembly 20 and/or the passive data ports of the lower dock subassembly 60. The exemplary embodiment in FIG. 1 shows an upstream cable 93 connected to the lower dock subassembly 60, which in turn can be connected to a laptop or other peripheral above the work surface 100. In another embodiment, the computer docking station 1 can operate with only the lower dock subassembly 60, which can connect directly to a power source and any computer peripherals without use of the upper dock subassembly 20.

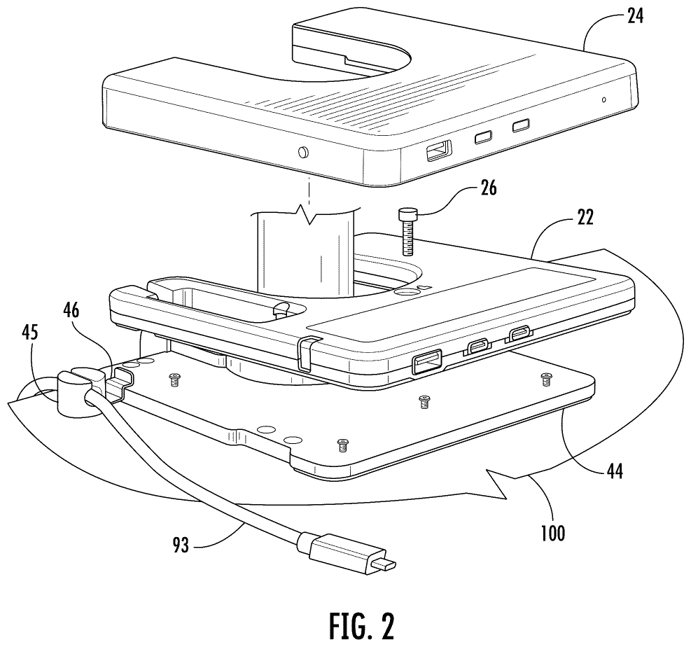

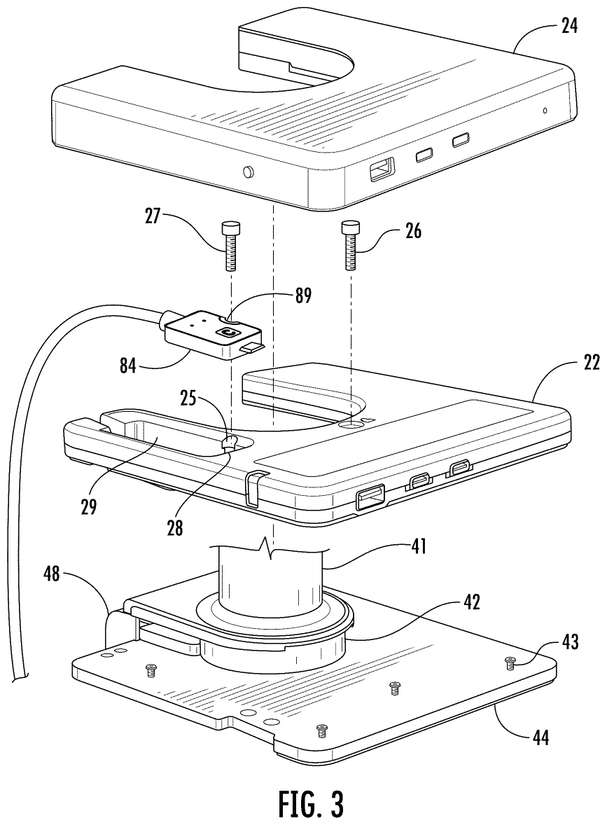

Both the upper and lower dock subassemblies 20, 60 releasably connect to a base subassembly 40 that secures the entire docking station 1 to a work surface or desk 100. Referring now to FIGS. 2-3, the base subassembly 40 comprises a monitor arm 41, a monitor arm mount 42, a mounting plate 44, a cable retainer 45, a cable retainer bracket 46, and a base bracket 48. An upper portion of the base bracket 48 is preferably attached to the rear or bottom of the mounting plate 44. The monitor arm mount 42 can be either attached to, or integrated into, the top of the mounting plate 44. The monitor arm 41 can be connected to the monitor arm mount 42, with one or more computer monitors mounted to the monitor arm 41 (not illustrated).

The cable retainer bracket 46 attaches the cable retainer 45 to the mounting plate 44 by inserting a vertical tab on the bracket 46 into a corresponding slot (not illustrated) in upper port housing 22. Upper port housing 22 includes a cable retainer slot on the left and right sides so that the user may attach the cable retainer 45 on either side of the upper dock subassembly 20. The cable retainer 45 is preferably made of an elastomeric polymer such that an opening slit across the top of the cable retainer separates sufficiently for a user to push the cable through the opening slit into a retention cavity, after which the opening slit will return to its closed position, thereby securing the cable. The cable retainer can then hold the cable in place on the work surface, allowing the user to unplug the computer peripheral connected to that cable without the cable falling to the floor. In one embodiment, the cable retainer holds an upstream cable 93 that connects the lower dock subassembly 60 to a laptop. However, one skilled in the art will recognize that the cable retainer could hold any cable that connects from the lower dock subassembly 60 to any peripheral that is frequently unplugged.

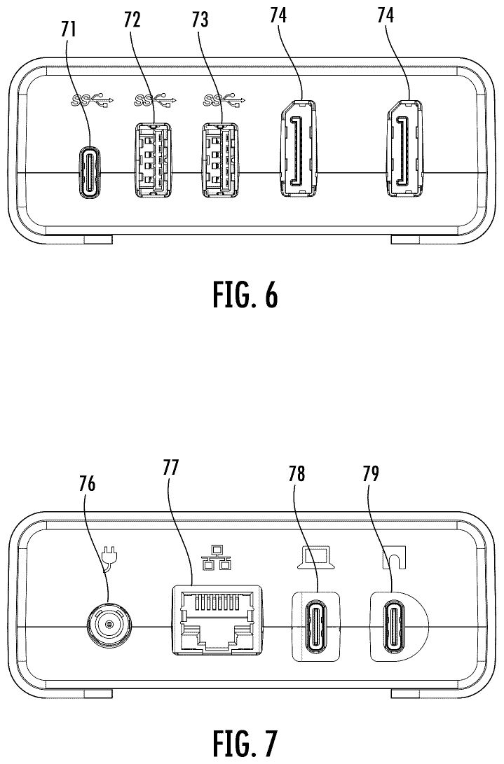

Viewing FIGS. 6-7, a device for securing the base subassembly 40 to a work surface 100 can comprise a clamp support 54 and one or more screws 52. The screws 52 are threadingly engaged with the clamp support 54. In order to secure the computer docking station 1 to a work surface 100, the user can rotate the screws 52 until the screws' distal ends 56 come into contact with the underside of the work surface 100. The screws 52 have Allen keyholes in the bottom that the user can engage with an Allen wrench to tighten the screws 52 (not illustrated). In a preferred embodiment, the clamp support 54 is attached to a base bracket 48 of the base subassembly 40 with a sufficient space in-between the screws 52 and the mounting plate 44 to accommodate a work surface 100 of varying thicknesses.

A variety of alternative mechanisms can be utilized to mount the base subassembly 40 to the work surface. For example, in a first alternative embodiment, clamp support 54 and screws 52 can be replaced with a fixed bracket that permanently attaches the computer docking station 1 to the work surface. In a second alternative embodiment, the clamp support 54 and screws 52 can be replaced with a means for removably mounting the computer docking station 1 to a slat wall. In a third alternative embodiment, the computer docking station 1 can utilize separate brackets to mount the lower dock subassembly 60 and the upper dock subassembly 20 to the work surface, thereby allowing for greater flexibility in mounting locations for each subassembly. In a fourth alternative embodiment, the upper dock subassembly 20 can be secured to the base subassembly 40 on the work surface 100, while the lower dock subassembly 60 is free hanging from a flexible connector to the base subassembly 20, thereby allowing the user to quickly adjust the positioning of the lower dock subassembly 60 relative to the upper dock subassembly 20. While FIGS. 1-19 depict the upper and lower dock subassemblies 20, 60 positioned in a horizontal orientation, one skilled in the art will readily appreciate that either or both of the dock subassemblies 20, 60 can alternatively be positioned in a vertical orientation.

As is suggested by FIG. 2, the upper dock subassembly 20 is designed to be releasably coupled to the mounting plate 44 of the base subassembly 40, providing users the benefit of more easily removing the upper dock subassembly 20 for repair or replacement without having to disassemble the entire computer docking station 1. This removability also allows users to more easily update hardware and allows a migration path for when technology is obsoleted/outdated and needs to be replaced with new standards. The upper dock subassembly 20 can include an upper port housing 22 and a removable cover 24. The upper port housing 22 is attached to the mounting plate 44 by inserting locating posts 43 protruding from the mounting plate 44 into slots (not illustrated) in the upper port housing 22 and then securing with one or more fasteners 26. The fastener 26 can be accessed by detaching the removable cover 24, which is releasably attached to the upper port housing 22 using a snap fit connection.

Referring now to FIG. 3, the adaptor port 28 is situated inside an adaptor recess 29 in the upper port housing 22. The adaptor recess 29 is shaped to house an adaptor cable connector 84 of an adaptor cable. When the adaptor cable connector 84 engages with the adaptor port 28, a fastener recess 89 on the adaptor cable connector 84 aligns with a fastener recess 25 in the adaptor recess 29 so as to form a threaded cavity. The adaptor cable connector 84 can then be secured to the upper port housing 22 by one or more fasteners 27 threadingly engaged with the threaded cavity. When the removable cover 24 is attached to the upper port housing 22, the adaptor recess 29 is completely covered, eliminating access to the adaptor cable connector 84 so that the user cannot inadvertently disrupt the connection. The fastener 27 and removable cover 24 both prevent the user from accidentally disconnecting the adaptor cable connector 84 during use, thereby providing a smoother user experience. However, if the user desires to disconnect the adaptor cable connector 84, the fastener 27 can be accessed by detaching the removable cover 24. In one embodiment, the adaptor port 28 is a USB-C port featuring DisplayPort Alt Mode functionality (i.e., a USB-C DisplayPort, or DP Alt Mode), but the adaptor port could be any data port capable of transmitting and receiving power, data, and audio.

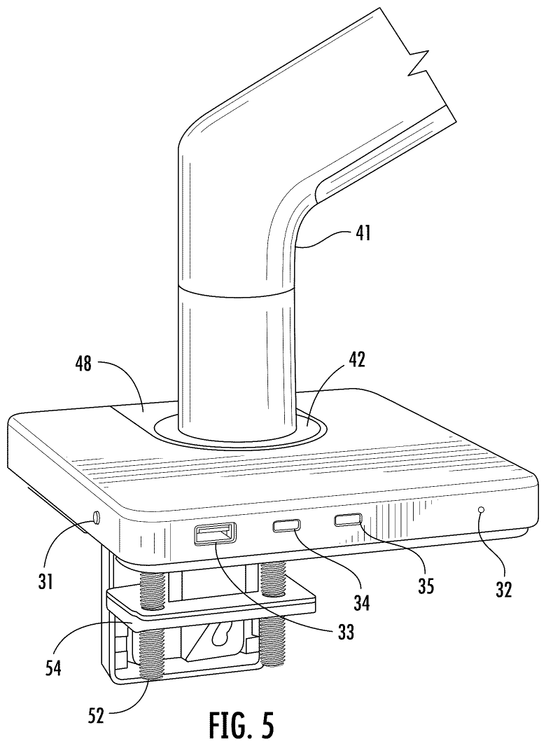

In the exemplary embodiment depicted in FIGS. 5-8, the upper dock subassembly 20 can feature an indicator light 32, a power button 31, and one or more active data ports (33-37). The indicator light 32 functions to provide the user feedback regarding the operation status of the computer docking station 1. Data port 33 can be a USB-A 3.2 (5 V/900 mA) data port, and ports 34 and 35 can be USB-C 3.2 (5 V/900 mA) data ports, which allow users to connect USB peripherals and mobile devices to the user's laptop via the computer docking station 1. Data port 36 can be a USB-C (max 30 W) charging port, and data port 37 can be a USB-A (max 5 V/2.4 A) charging port. In alternative embodiments, one skilled in the art will readily acknowledge that the locations and types of data ports 33-37 can easily be modified to adapt to changing technologies and uses of the data ports. For example, the back of the upper port housing 22 can be used to accommodate one or more of the active data ports 33-37. In certain embodiments, the upper dock subassembly 20 can also feature a wireless charging platform for mobile devices.

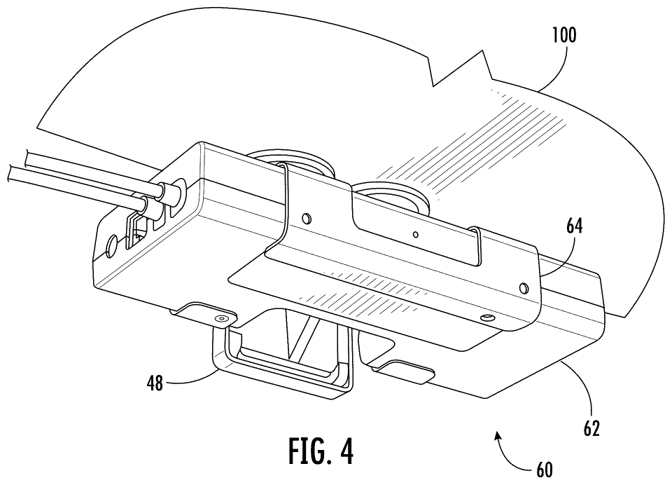

Viewing FIG. 4, the lower dock subassembly 60 comprises a lower port housing 62 and a dock frame 64. A lower portion of the base bracket 48 removably attaches to the lower dock subassembly 60 beneath the work surface 100. The dock frame 64 includes slots that engage with locating posts on the base bracket 48, allowing the lower dock subassembly 60 to be easily connected and disconnected (not illustrated).

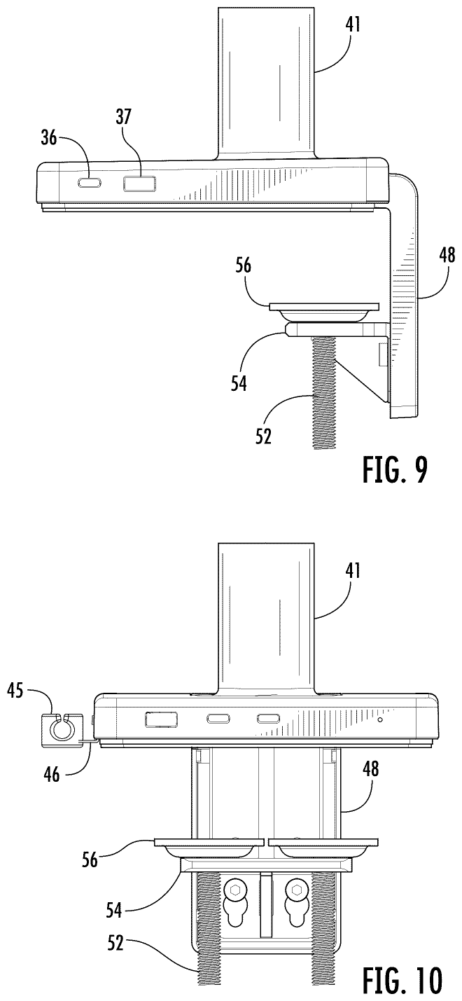

In the exemplary embodiment depicted in FIGS. 9-13, the lower dock subassembly 60 can feature one or more passive power and data ports 71-79. Data port 71 can comprise a USB-C 3.2 (5 V/1.5 A) data and charging port, and data ports 72 and 73 can comprise USB-A 3.2 (5 V/900 mA) data ports, all of which allow users to connect USB peripherals to the user's laptop via the computer docking station 1. In alternative embodiments, data ports 71-73 can be any type of USB port or other data port. Data ports 74 and 75 can comprise Display Port data ports for allowing monitor(s) to be connected to the computer docking station 1. Alternatively, these data ports could be DVI, HDMI, or USB-B type data ports.

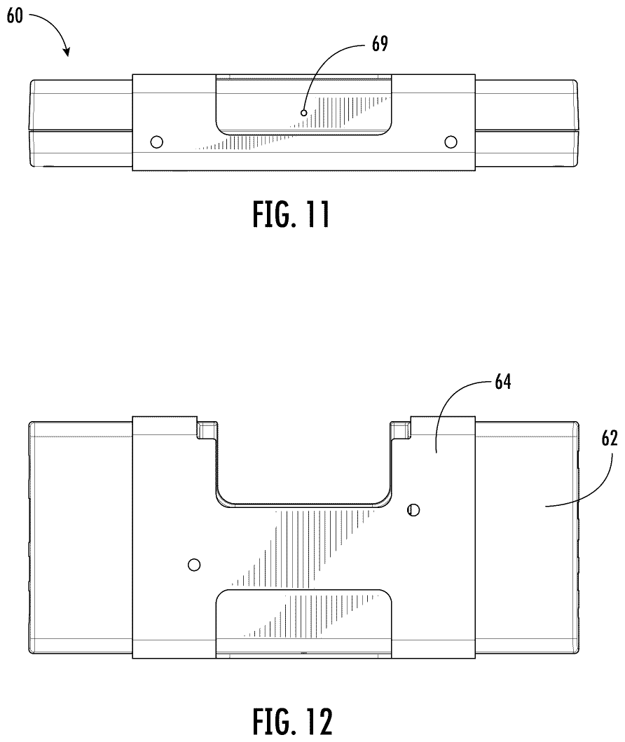

Referring now to FIG. 10, data port 76 can comprise a DC power port through which power is supplied to the lower dock subassembly 60. Data port 77 can comprise an Ethernet port (10/100/1000 Base-T) for providing the user's laptop with a wired internet connection through the computer docking station 1. Data port 78 can comprise a USB-C 3.2 (100 W PD 3.0) upstream port designed to be linked to the user's laptop. The upstream port 78 allows for the transfer of data, video, and audio information between the computer and peripherals through the computer docking station 1, as well as the transfer of power. Data port 79 can comprise a USB-C 3.2 (45 W) bridge port capable of being mated to an adaptor cable 83 for transferring data between the upper dock subassembly 20 and the lower dock subassembly 60. In alternative embodiments, one skilled in the art will readily acknowledge that the locations and types of data ports 71-79 can easily be modified to adapt to changing technologies and uses of the data ports. The lower dock subassembly 60 may further comprise an indicator light 69, as shown in FIG. 11. The indicator light 69 functions to provide the user feedback regarding the operation status of the computer docking station 1.

FIGS. 17-19 demonstrate three exemplary modes of programmed operation for the computer docking station 1, specifically the upper dock subassembly 20. One skilled in the art will recognize that the adaptor port 28 of the upper dock subassembly 20 allows the computer docking station 1 to be used in many different configurations and that the three modes outlined below are merely demonstrative of the multi-functional capabilities of the computer docking station 1. Referring to FIG. 17, the illustrated Split Dock Mode utilizes both the upper dock subassembly 20 and the lower dock subassembly 60 for operation. The adaptor port 28 of the upper dock subassembly 20 can connect to the bridge port 79 of the lower dock subassembly 60 via an adaptor cable 82. One embodiment of an adaptor cable 82 that may be used in this mode is depicted in FIG. 15, wherein one end is a USB-C adaptor cable connector 84 capable of mating to the USB-C adaptor port 28, and the other end is a USB-C connector 86 capable of mating to the USB-C bridge port 79. In this mode, the lower dock subassembly 60 also connects to a power supply 94, a monitor 96 via a digital connector cable 91 (e.g., a DisplayPort cable), and a laptop 98 via an upstream cable 93.

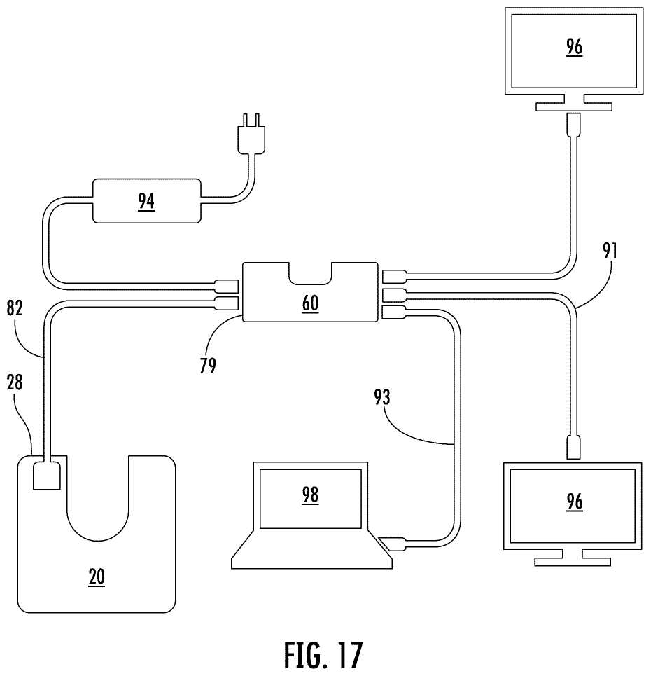

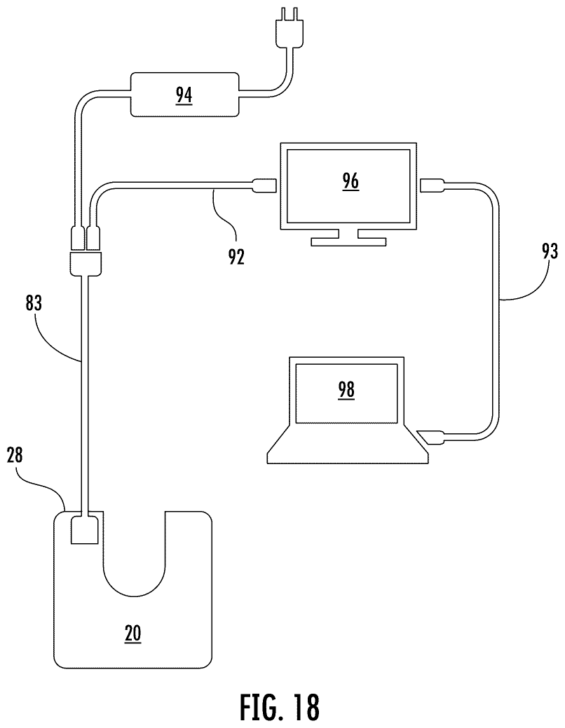

Referring now to FIG. 18, the depicted Hub Mode allows the upper dock subassembly 20 to transmit power, data, audio, and video without the lower dock subassembly 60. In this mode, the adaptor port 28 of the upper dock subassembly 20 may be connected to both a power supply 94 and a computer monitor 96 through one adaptor cable 83. The monitor can connect to the user's laptop through any suitable upstream cable 93. One embodiment of an adaptor cable 83 that may be used in this mode is depicted in FIG. 16, wherein one end is a USB-C adaptor cable connector 84 capable of mating to the USB-C adaptor port 28, and the other end has both a DC power port 88 capable of mating to an AC adaptor 94 and a USB-B port 87 capable of mating to a connector cable 92 that connects to the monitor 96. In alternative embodiments, the USB-B port 87 can be replaced by a USB-C port or any other data port capable of transmitting data, visual, and audio signals.

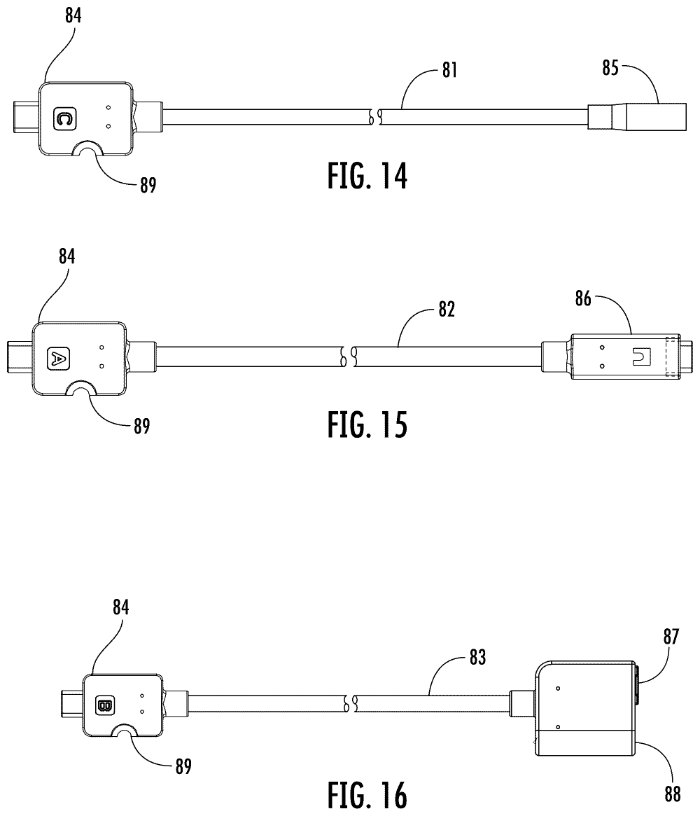

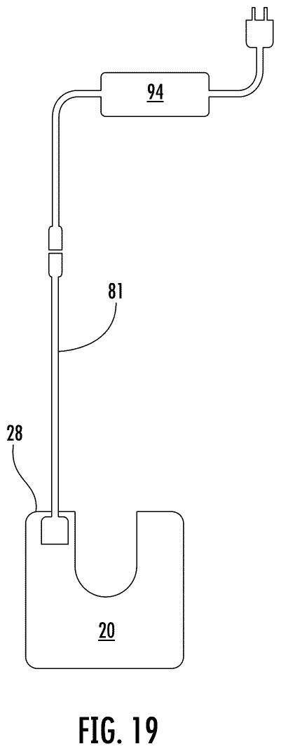

Referring now to FIG. 19, in the illustrated Charging Mode, the adaptor port 28 of the upper dock subassembly 20 may be connected to a power supply 94 via an adaptor cable 81. In this mode, the manufacturer adds a resistor in the hub controller of the upper dock subassembly's printed circuit board assembly (PCBA). This resistor disables the data function on the ports 31-37, but allows the ports 31-37 to still provide power for the charging function. One embodiment of an adaptor cable 81 that may be used in this mode is depicted in FIG. 14, wherein one end is a USB-C adaptor cable connector 84 capable of mating to the USB-C adaptor port 28, and the other end is a DC power port 85 capable of mating to an AC adaptor 94.

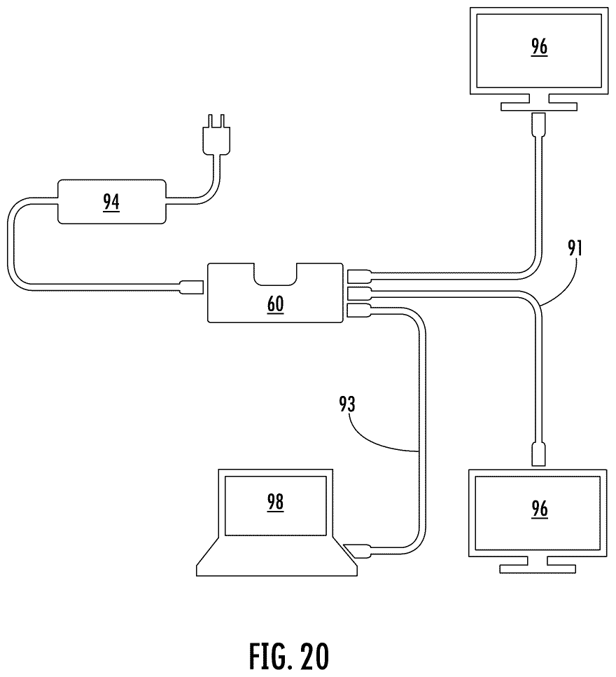

Referring now to FIG. 20, the illustrated Dock Mode allows the lower dock subassembly 60 to transmit power, data, audio, and video without the upper dock subassembly 20. In this mode, the DC power port 76 of the lower dock subassembly 60 may be connected to a power supply 94, the upstream port 78 may be connected to a laptop 98 via upstream cable 93, and the bridge port 79 or any of the other data ports 71-74 may be connected to a computer monitor 96 via a suitable digital connector cable 91.

The foregoing description and accompanying drawings illustrate the principles, exemplary embodiments, and modes of operation of the invention. However, the invention should not be construed as being limited to the particular embodiments discussed above. Many modifications of the embodiments described herein will come to mind to one skilled in the art having the benefit of the teaching presented in the foregoing descriptions and the associated drawings. Accordingly, it should be appreciated that variations to those embodiments can be made by those skilled in the art without departing from the scope of the invention.

What is claimed is:

1. A computer docking station comprising a base subassembly that is configured to secure an upper dock subassembly to a work surface, the upper dock subassembly comprising an upper port housing having one or more active data ports and one or more adaptor ports, wherein the upper dock subassembly is configurable to operate in one of the following modes:
a) a charging mode, wherein at least one of the adaptor ports is operatively connected to a power source via an adaptor cable;
b) a hub mode, wherein the adaptor port is operatively connected to both a power source and a computer peripheral via an adaptor cable; and
c) a split dock mode, wherein the adaptor port is operatively connected to a bridge port of a lower dock subassembly via an adaptor cable, wherein the lower dock subassembly comprises a lower port housing having one or more passive data ports and is configured to be secured beneath the work surface by the base subassembly.

2. The computer docking station of claim 1, wherein the adaptor cable comprises a first end and a second end, wherein the first end is an adaptor cable connector that engages with the adaptor port of the upper dock subassembly.

3. The computer docking station of claim 2, wherein the second end of the adaptor cable comprises a DC power port that engages with the power source when the upper dock subassembly operates in charging mode.

4. The computer docking station of claim 2, wherein the second end of the adaptor cable comprises a USB data port and a DC power port that engage with the computer peripheral and the power source, respectively, when the upper dock subassembly operates in hub mode.

5. (canceled)

6. The computer docking station of claim 2, wherein the second end of the adaptor cable comprises a USB data connector that engages with the bridge port of the lower dock subassembly when the upper dock subassembly operates in split dock mode.

7. The computer docking station of claim 1, wherein the upper port housing further comprises an adaptor recess in which an adaptor cable connector rests when it engages the adaptor port, and wherein the adaptor cable connector is affixed to the upper port housing using one or more fasteners inside the adaptor recess.

8-9. (canceled)

10. The computer docking station of claim 7, wherein the upper dock subassembly further comprises a removable cover that releasably attaches to the upper port housing and shields the adaptor cable connector when it rests in the adaptor recess.

11. (canceled)

12. The computer docking station of claim 1, wherein the one or more active data ports comprise a first active data port, a second active data port, and a third active data port, wherein at least one of the first, second, or third active data ports is selected from a group consisting of a USB data port and a USB charging port.

13-15. (canceled)

16. The computer docking station of claim 1, wherein the base subassembly comprises a mounting plate having a top surface and a bottom surface, wherein the upper dock subassembly is configured to be releasably attached to the top surface of the mounting plate, and wherein the base subassembly further comprises a monitor arm mount attached or integrally formed to the top surface of the mounting plate.

17-20. (canceled)

21. The computer docking station of claim 16, wherein the base subassembly further comprises a bracket and one or more screws threadingly engaged with a clamp support.

22. The computer docking station of claim 1, wherein the lower dock subassembly further comprises a dock frame, which holds the lower port housing of the lower dock subassembly and comprises slots that engage with locating posts on the bracket of the base subassembly.

23. The computer docking station of claim 1, wherein the one or more passive data ports comprise a first passive data port, a second passive data port, and a third passive data port, wherein at least one of the first, second, or third passive data ports is selected from a group consisting of an Ethernet port, a DisplayPort data port, an HDMI data port, a DVI data port, a USB port, and a DC power connector.

24-25. (canceled)

26. A computer docking station comprising:
a) an upper dock subassembly configured to be positioned on top of a work surface, the upper dock subassembly comprising:
i) an upper port housing having one or more active data ports and one or more adaptor ports;
ii) one or more adaptor recesses in the upper port housing in which an adaptor cable connector rests when it engages the adaptor port; and
iii) a removable cover that releasably attaches to the upper port housing and shields the adaptor cable connector when it rests in the adaptor recess.
b) a base subassembly that secures the upper dock subassembly to the work surface.

27-28. (canceled)

29. The computer docking station of claim 26, wherein the adaptor cable connector includes a first fastener recess that aligns with a second fastener recess located inside the adaptor recess of the upper port housing to form a threaded cavity with which a fastener may threadingly engage to affix the adaptor cable connector to the upper port housing.

30. The computer docking station of claim 26, wherein the adaptor port is operatively connected to a power source via an adaptor cable.

31. (canceled)

32. The computer docking station of claim 26, wherein the adaptor port is operatively connected to both a power source and a computer peripheral via an adaptor cable.

33-34. (canceled)

35. The computer docking station of claim 26, wherein the adaptor port is operatively connected to a bridge port of a lower dock subassembly via an adaptor cable, wherein the lower dock subassembly comprises a lower port housing having one or more passive data ports and is configured to be secured beneath the work surface by the base subassembly.

36. (canceled)

37. The computer docking station of claim 35, wherein the lower dock subassembly further comprises a dock frame, which holds the lower port housing of the lower dock subassembly and is releasably attached to the base subassembly.

38. The computer docking station of claim 26, wherein the base subassembly comprises a mounting plate having a top surface and a bottom surface, wherein the upper dock subassembly is configured to be releasably attached to the top surface of the mounting plate by inserting locating posts protruding from the mounting plate into slots in the upper port housing and then securing with one or more fasteners.

56. A computer docking station comprising a base subassembly that is configured to secure an upper dock subassembly and a lower dock subassembly to a work surface, wherein the upper dock subassembly comprises an upper port housing having one or more active data ports and one or more adaptor ports, and the lower dock subassembly comprises a lower port housing having one or more passive data ports and a DC power port, wherein the computer docking station is configurable to operate in one of the following modes
a) a charging mode, wherein at least one of the adaptor ports of the upper dock subassembly is operatively connected to a power source via an adaptor cable;
b) a hub mode, wherein the adaptor port of the upper dock subassembly is operatively connected to both a power source and a computer peripheral via an adaptor cable;
c) a split dock mode, wherein the adaptor port of the upper dock subassembly is operatively connected to a bridge port of the lower dock subassembly via an adaptor cable, and the DC power port of the lower dock subassembly is operatively connected to a power source; and
d) a dock mode, wherein an upstream port of the lower dock subassembly is operatively connected to a computer peripheral, and the DC power port of the lower dock subassembly is operatively connected to a power source.
